(19) United States
(12) Patent Application Publication
(10) Pub. No.: US 2019/0098703 A1
(43) Pub. Date: Mar. 28, 2019

(54) HEATING ELEMENTS AND HEATING DEVICES

(71) Applicant: E I DU PONT DE NEMOURS AND COMPANY, Wilmington, DE (US)

(72) Inventor: Jonathan A. Weldon, Durham, NC (US)

(21) Appl. No.: 16/142,504

(22) Filed: Sep. 26, 2018

Related U.S. Application Data
(60) Provisional application No. 62/563,346, filed on Sep. 26, 2017.

(51) Int. Cl. H05B 3/14; H05B 3/00; H05B 3/03; H05B 3/06; H05B 3/34

(52) U.S. Cl. CPC H05B 3/146; H05B 3/0023; H05B 3/03; H05B 2203/023; H05B 3/34; H05B 2203/007; H05B 3/06

(57) ABSTRACT

In a first aspect, a heating element includes a network of electrically conductive layers comprising a plurality of polymeric resistive layers and two or more electrodes in contact with the network of electrically conductive layers. The polymeric resistive layers have a sheet resistance in a range of from about 0.5 ohm/square to about 2 Megaohm/square. The array of electrodes electrically connects the heating element to a power source. In a second aspect, a forced-convection heating device comprising the heating element of the first aspect.

### BACKGROUND INFORMATION

### Field of the Disclosure

This disclosure relates to heating elements and heating devices.

### Description of the Related Art

In a traditional gasoline powered vehicle using a combustion engine, heat produced by the engine during operation is used to provide heat to the passenger compartment via the radiator and forced convection of hot air. Improvements made to reduce emissions, however, have resulted in higher efficiency engines that produce less heat. In the case of hybrid electric and electric vehicles (HEV and EV), the engine is either a secondary power source or not present, therefore producing little (HEV) to no (EV) heat. Moreover, traditional vehicles with internal combustion engines are becoming increasingly efficient which also reduces the excess engine heat generation typically used for the auxiliary heating. For vehicles with minimal heat generated by the engine, Positive Temperature Coefficient (PTC) ceramic materials attached to heat exchangers (e.g., heat sinks) have been used as heating elements in a forced convection design to provide heat for the passenger compartment. For example, multiple bars of PTC heating elements can be attached to an array of metal fins that act as heat sinks to more efficiently distribute the heat. The heating elements are typically confined to small areas, due to their mechanical properties, and rely on thermal interfaces and well-designed metallic structures to sink the generated heat to a convective air flow. The confined nature of the heating element limits its size and, coupled with the thermal interface and heat sink requirements, have driven these technologies to a performance plateau (i.e., 5 kW or 180° C. heater temperature). Powering electric PTC heaters can put high demands on the batteries of hybrid electric and electric vehicles, especially in cold climates when high heat output is most needed. Furthermore, ceramic materials used in electric PTC heat systems, in addition to being heavy, bulky and brittle, take time to “warm-up” and provide adequate heat to the heating device.

Metal pastes have been used to create resistive heating elements supported by temperature resistant films. European Patent No. 2 181 015 discloses relatively thin heater devices useful in applications such as seats and steering wheels in automobiles. The heater device includes a polyimide dielectric substrate layer with a resistive layer of carbon-filled polyimide overlaying the substrate layer, and a conductor which acts as both an electrode and bus structure overlaying and in contact with the resistive layer. The electrodes and bus structure can be provided in the form of a metal paste, such as a printable conductive ink. U.S. Pat. No. 8,263,202 discloses film-based heating devices with a resistive polyimide base film containing electrically conductive filler, such as carbon black, adhered to metal foil bus bars using a conductive adhesive. By using metal foil as bus bars instead of metal paste, the voltage stability along the length of the bus bar is greatly improved but the adhesive system may limit performance. This film-based heating device may include a secondary base film of a dielectric material, such as polyimide.

While these heating devices may be useful in small-scale applications in relatively hospitable environments at modest temperatures and with lower voltages, producing polymer-based heating devices for larger applications with greater power output is much more challenging. There is a need for lighter weight heating elements for forced convection heating devices with improved power, lower power density and increased maximum operating temperature.

### SUMMARY

In a first aspect, a heating element includes a network of electrically conductive layers comprising a plurality of polymeric resistive layers and two or more electrodes in contact with the network of electrically conductive layers. The polymeric resistive layers have a sheet resistance in a range of from about 0.5 ohm/square to about 2 Megaohm/square. The array of electrodes electrically connects the heating element to a power source.

In a second aspect, a forced-convection heating device comprising the heating element of the first aspect.

### DETAILED DESCRIPTION

In a first aspect, a heating element includes a network of electrically conductive layers comprising a plurality of polymeric resistive layers and two or more electrodes in contact with the network of electrically conductive layers. The polymeric resistive layers have a sheet resistance in a range of from about 0.5 ohm/square to about 2 Megaohm/square. The array of electrodes electrically connects the heating element to a power source.

In one embodiment of the first aspect, the polymeric resistive layers include a first polymeric dielectric material. In a specific embodiment, the first polymeric dielectric material includes a polyimide.

In another embodiment of the first aspect, the first polymeric resistive layers further include electrically conductive filler.

In yet another embodiment of the first aspect, the electrically conductive layers further include a plurality of polymeric dielectric layers in contact with the plurality of polymeric resistive layers. In a specific embodiment, the polymeric dielectric layers include a second polymeric dielectric material. In a more specific embodiment, the second polymeric dielectric material includes a polyimide.

In still another embodiment of the first aspect, the two or more electrodes include an electrically conductive paste or a metal.

In still yet another embodiment of the first aspect, the network is an open cellular network. In a specific embodiment, the open cellular network includes a honeycomb cellular geometry.

In a further embodiment of the first aspect, the electrically conductive layers further include one or more vias.

In yet a further embodiment of the first aspect, the electrically conductive layers further include one or more outer dielectric layers.

In still a further embodiment of the first aspect, the heating element further includes an encapsulant.

In still yet a further embodiment of the first aspect, the heating element further includes a frame or mechanical support structure.

In a second aspect, a forced-convection heating device comprising the heating element of the first aspect.

In one embodiment of the second aspect, the forced-convection heating device further includes one or more bus bars electrically connected to the heating element.

Many aspects and embodiments have been described above and are merely exemplary and not limiting. After reading this specification, skilled artisans appreciate that other aspects and embodiments are possible without departing from the scope of the invention. Other features and advantages of the invention will be apparent from the following detailed description, and from the claims.

### Definitions

The following definitions are used herein to further define and describe the disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the terms “a” and “an” include the concepts of “at least one” and “one or more than one”.

Unless stated otherwise, all percentages, parts, ratios, etc., are by weight.

When the term “about” is used in describing a value or an end-point of a range, the disclosure should be understood to include the specific value or end-point referred to.

### Heating Element

In one embodiment, a network of electrically conductive layers for a heating element includes a plurality of polymeric resistive layers. In one embodiment, a polymeric resistive layer can include a first polymeric dielectric material. In one embodiment, a network of electrically conductive layers can further include a plurality of polymeric dielectric layers in contact with the plurality of polymeric resistive layers. In one embodiment, a polymeric dielectric layer can include a second polymeric dielectric material. The first and second polymeric dielectric materials can each include a polyimide, a tetrafluoroethylene hexafluoropropylene copolymer (FEP), a perfluoroalkoxy polymer (PFA), a polyvinyl fluoride (PVF), a polyvinylidene fluoride (PVDF), a polyester (such as polyethylene terephthalate (PET) or polyethylene naphthalate (PEN)), a polyether ether ketone (PEEK), a polycarbonate (PC) or a mixture thereof. In one embodiment, the first and second polymeric dielectric materials can be the same or different. In one embodiment, the polymeric resistive layer and the polymeric dielectric layer can each include a screen printed or photoimageable epoxy, a silicone, a filled epoxy, a filled silicone, or a mixture thereof.

In one embodiment, a polyimide can be an aromatic polyimide. In a specific embodiment, an aromatic polyimide can be derived from at least one aromatic dianhydride and at least one aromatic diamine. In one embodiment, the polyimide material of the resistive layer and the polyimide material of the dielectric layer can be the same or different.

In one embodiment, the polymeric resistive layer includes electrically conductive filler in a range of from about 10 to about 45 weight percent based upon the total weight of the polymeric resistive layer. In a specific embodiment, the electrically conductive filler is present in a range of from about 15 to about 40 weight percent based upon the total weight of the polymeric resistive layer. In a more specific embodiment, the electrically conductive filler is present in a range of from about 20 to about 35 weight percent based upon the total weight of the polymeric resistive layer. In some embodiments, the electrically conductive filler is carbon black. In some embodiments, the electrically conductive filler is selected from the group consisting of acetylene blacks, super abrasion furnace blacks, conductive furnace blacks, conductive channel type blacks and fine thermal blacks and mixtures thereof.

In some embodiments, the electrically conductive filler has an electrical resistance of at least 100 ohm/square. In some embodiments, the electrically conductive filler has an electrical resistance of at least 1000 ohm/square. In another embodiment, the electrically conductive filler has an electrical resistance of at least 10,000 ohm/square. In some embodiments, the electrically conductive filler is metal or metal alloy. In some embodiments, the electrically conductive filler is a mixture of electrically conductive fillers. In some embodiments, the electrically conductive filler is milled to obtain desired agglomerate size (particle size). In one embodiment, the average particle size of the electrically conductive filler is in a range of from about 0.05 to about 1 μm. The average particle size can be determined using a Horiba Light Scattering Particle Size Analyzer (Horiba, Inc., Japan). In one embodiment, the average particle size of the electrically conductive filler is in a range of from about 0.1 to about 0.5 μm. Generally, an average particle size above 1 μm is more likely to cause electrical shorts and/or hot spots. In one embodiment, the electrically conductive filler particle size is less than or equal to 1 μm. Ordinary skill and experimentation may be necessary in fine tuning the type and amount of electrically conductive filler sufficient to achieve desired resistance depending upon the particular application. In one embodiment, the polymeric resistive layer includes a polyimide material with electrically conductive filler and has a sheet resistance in a range of from about 0.5 ohm/square to about 2 Megaohm/square measured using an FPP5000 four point probe (Veeco Instruments, Inc., Somerset, N.J.). In one embodiment, the polymeric resistive layer has a sheet resistance in a range of from about 2 ohm/square to about 10,000 ohm/square. In a specific embodiment, the polymeric resistive layer has a sheet resistance in a range of from about 10 to about 500 ohm/square. In a more specific embodiment, the polymeric resistive layer has a sheet resistance in a range of from about 50 to about 150 ohm/square.

In one embodiment, the heating element optionally includes a non-electrically conductive filler in either the polymeric resistive layers, the polymeric dielectric layers or both. Non-electrically conductive fillers may be included to improve thermal conductivity, mechanical properties, etc. In some embodiments, a non-electrically conductive filler is selected from the group consisting of metal oxides, carbides, borides and nitrides. In a specific embodiment, the non-electrically conductive filler is selected from the group consisting of aluminum oxide, titanium dioxide, silica, mica, talc, barium titanate, barium sulfate, dicalcium phosphate, and mixtures thereof.

In one embodiment, electrically conductive layers further include an array of electrically conductive vias, or openings, in the electrically conductive layers, that may be used to provide electrical connection between individual electrically conductive layers, as well as electrically connecting the heating element to the power source of the heating device. Conductive vias can be through-hole, blind, or buried and can be plated or filled with conductive material that is either sintered or cured. Conductive materials can include conductive metals, conductive pastes, conductive inks or any other conductive material commonly used in printed circuit board manufacture. In one embodiment, vias may be filled with a conductive material selected from a variety of electrically conductive inks or pastes, such as DuPont CB Series screen printed ink materials, DuPont 5025 silver conductor and DuPont™ Kapton™ KA801 polyimide silver conductor (all available from DuPont Microcircuit Materials, Research Triangle Park, N.C.).

In one embodiment, the network of electrically conductive layers of a heating element can be in the form of an open cellular network. As used herein, the term “open cellular network” refers to a periodic three-dimensional structure wherein an array of geometric structures form walls around openings. In one embodiment, an open cellular network can be an array of hexagons that form a “honeycomb” structure (i.e., a honeycomb cellular geometry). A honeycomb structure provides adequate mechanical rigidity to support a heating element and fit it into a forced convection heating system while also providing an improved heat sink structure. In another embodiment, an open cellular network may be an array of squares, rectangles, rhombi, triangles, or more complex geometric structures with curved walls. In one embodiment, an open cellular network can be a mixture of two or more geometric shapes. Those skilled in the art will appreciate the wide variety of shapes that can form an open cellular network and that the periodic structure need not be perfectly uniform in size and shape across the array.

In one embodiment, the open cellular network has a wall thickness in a range of from about 2 to about 250 μm. In a specific embodiment, the wall thickness is in a range of from about 10 to about 150 μm. In a more specific embodiment, the wall thickness is in a range of from about 25 to about 75 μm. In one embodiment, the polymeric resistive layers have a thickness in the range of from about 2 to about 100 μm. In a specific embodiment, the polymeric resistive layers have a thickness in the range of from about 10 to about 50 μm. In one embodiment, where the electrically conductive layer includes a polymeric dielectric layer, the polymeric dielectric layer has a thickness in the range of from about 2 to about 100 μm. In a specific embodiment, the polymeric dielectric layer has a thickness in the range of from about 10 to about 50 μm. In one embodiment, a polymeric resistive layer and a polymeric dielectric layer may be coextruded to form the electrically conductive layer. In one embodiment, a heating element having an open cellular network can be derived from a Kapton® 200RS100 polyimide film (available from E.I. du Pont de Nemours and Co., Wilmington, Del.).

In one embodiment, the network of electrically conductive layers of a heating element can be in the form of spaced-apart layers (i.e., fins). The spaced-apart layers can be physically connected or separated from each other, but are electrically connected to provide heat to the heating device. Adequate space is provided between the fins to allow for good air flow in a forced convection heating system.

In one embodiment, a heating element may further include an encapsulant. An encapsulant may be a resin system (phenolic, epoxy, etc.) that provides electrical insulation and mechanical rigidity, if needed, to the network of electrically conductive layers. In one embodiment, an encapsulant may be a dielectric material that is either coated or laminated onto the heating element.

### Bus Bars

In one embodiment, a heating device includes one or more bus bars electrically connected to a heating element. In one embodiment, the bus bar(s) include a first patterned conductive material (e.g., an electrically conductive paste, a metal, etc.). In one embodiment, the first patterned conductive material is a highly conductive material (e.g., copper, silver, gold, etc.) that enables electrical current to be efficiently and uniformly delivered to the heating element. In one embodiment, bus bars may include a metal foil, either standalone or adhered to a dielectric material, with a metal foil thickness of from about 5 to about 140 μm (i.e., 0.5 oz. to 4 oz. metal foil) and a minimum dielectric thickness of 12.5 to 75 μm. A patterned trace can be designed to optimize the uniformity of the current being delivered to the heating element.

In one embodiment, bus bar(s) include(s) a third polymeric dielectric material. The third polymeric dielectric material may provide mechanical support for the first patterned conductive material, as well as electrically insulating the first patterned conductive material from unwanted electrical connections. The third polymeric dielectric material can include any of the dielectric materials described above for the first and second polymeric dielectric materials, and can be the same or different as one or both of the first and second polymeric dielectric materials.

In one embodiment, the bus bar(s) for a heating device can be adhered to a polymeric dielectric layer of the heating element via an adhesive layer. In one embodiment, an adhesive layer can include a thermally cured adhesive, such as an acrylic adhesive (e.g., Pyralux® LF adhesive, DuPont, which can be cure at 150-180° C. and 150 psi) or a thermoplastic adhesive (e.g., Pyralux® HT bonding film, DuPont, which cures at high temperature and pressure, upwards of 350° C. and 450 psi). In one embodiment, an epoxy adhesive or a pressure sensitive acrylic adhesive may be used.

### Electrodes

In one embodiment, one or more electrodes for a heating element include a second patterned conductive material (e.g., an electrically conductive paste, a metal, etc.) that is adhered to the polymeric resistive layer of the electrically conductive layer. In one embodiment, the second patterned conductive material can be an electrically conductive paste. In one embodiment, the electrically conductive paste can include a polyimide polymer represented by formula I:

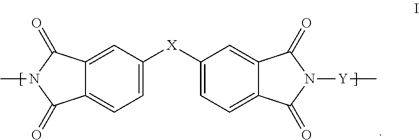

wherein X is C(CH₃)₂, O, SO₂ or C(CF₃)₂, O—Ph—C(CH₃)₂—Ph—O, O—Ph—O— or a mixture of two, or more of C(CH₃)₂, O, SO₂, and C(CF3)₂, O—Ph—C(CH₃)₂—Ph—O, O—Ph—O—;
wherein Y is diamine component or mixture of diamine components selected from the group consisting of:
m-phenylenediamine (MPD), 3,4′-diaminodiphenyl ether (3,4′-ODA), 4,4′-diamino-2,2′-bis(trifluoromethyl)biphenyl (TFMB), 3,3′-diaminodiphenyl sulfone (3,3′-DDS), 4,4′-(Hexafluoroisopropylidene)bis(2-aminophenol) (6F-AP) bis-(4-(4-aminophenoxy)phenyl)sulfone (BAPS) and 9,9-bis(4-aminophenyl)fluorene (FDA); 2,3,5,6-tetramethyl-1,4-phenylenediamine (DAM), 2,2-bis[4-(4-aminophenoxyphenyl)]propane (BAPP), 2,2-bis[4-(4-aminophenoxyphenyl)] hexafluoropropane (HFBAPP), 1,3-bis(3-aminophenoxy) benzene (APB-133), 2,2-bis(3-aminophenyl)hexafluoropropane, 2,2-bis(4 aminophenyl)hexafluoropropane (Bis-A-AF), 4,4′-bis(4-amino-2-trifluoromethylphenoxy) biphenyl, 4,4′-[1,3-phenylenebis(1-methyl-ethylidene)] bisaniline (Bisaniline-M) with the proviso that:
i. if X is O, then Y is not m-phenylenediamine (MPD), bis-(4-(4-aminophenoxy)phenyl)sulfone (BAPS) and 3,4′-diaminodiphenyl ether (3,4′-ODA); BAPP, APB-133, Bisaniline-M;
ii. if X is SO₂, then Y is not 3,3′-diaminodiphenyl sulfone (3,3′-DDS);
iii. if X is C(CF₃)₂, then Y is not m-phenylenediamine (MPD), bis-(4-(4-aminophenoxy)phenyl)sulfone (BAPS), 9,9-bis(4-aminophenyl)fluorene (FDA), and 3,3′-diaminodiphenyl sulfone (3,3′-DDS);
iv. if X is O—Ph—C(CH₃)₂—Ph—O or O—Ph—O—, then Y is not m-phenylene diamine (MPD), FDA, 3,4′-ODA, DAM, BAPP, APB-133, bisaniline-M.

This paste is advantageous in that it contains solvents which are not based on the typical DMAC or NMP solvents normally used with polyimides, but based on solvents which are more amenable to screen printing, having less toxicity and better handling, viscosity and drying processing windows for routine screen printing. Because this conductive paste is based on polyimide chemistry, it is also thermally stable after printing and drying and enables good electrical connection to the polymeric resistive layer of the electrically conductive layer, such that an electrode for a heating element that can operate at high-temperature can be made.

In one embodiment, conductive metal powder, such as silver, in an organic solution of a solvent soluble polyimide can form an electrically conductive paste which is amenable to screen printing. Useful solvents include dipropylene glycol methyl ether (DOWANOL™ DPM, Dow Chemical Co., Midland, Mich.), propylene glycol methyl ether acetate (DOWANOL™ PMA, Dow Chemical), di-basic esters, lactamides, acetates, diethyl adipate, texanol, glycol ethers, carbitols, and the like. Such solvents can dissolve the solvent-soluble polyimide resin and render a solution to which Ag and other electrically conductive metal powders can be dispersed, rendering a screen-printable paste composition. Solution of the polyimide resin in the selected solvents is possible through the selection of the monomers used to make the polyimide. In some embodiments, metals other than Ag, such as Ni, Cu, Pt, Pd and the like, and powders of various morphologies and combinations of those morphologies may be used.

In one embodiment, the electrically conductive paste can be printed to a thickness of 10 to 15 μm wet on the polymeric resistive layer of the electrically conductive layer, then dried at 130° C. in air for 10 minutes then dried again at 200° C. for 10 minutes. The size and placement of the electrodes of the electrically conductive paste can be chosen based on the resistivity of the polymeric resistive layer at the desired operating temperature and voltage of the heating element, and the overall size of the heating element. In a particular embodiment, the operating temperature may be about 200° C. and the voltage may be 220 V.

In one embodiment, the second patterned conductive material can be a metal (e.g., Al, Cu, Ag, Au, Ni, etc.), a metal alloy (e.g., CrNi, CuNi, etc.) or a metal oxide (e.g., AlO2, ITO, IZO, etc.). In one embodiment, the electrode is formed by sputter deposition of a metal and subsequent plating of the metallic layer to achieve the desired metal thickness. The resulting metallic layer can then be patterned to form electrodes using subtractive methods common to printed circuit board manufacturing.

In one embodiment, the electrode has a thickness in the range of from about 0.155 to about 250 μm. In a specific embodiment, when the second patterned conductive material is an electrically conductive paste, the polymeric dielectric layer has a thickness in the range of from about 5 to about 250 μm, or from about 5 to about 50 μm. In one embodiment, the electrically conductive paste in the electrode includes Ag powder in a range of from about 40 to about 80 wt % based on the total weight of the dried paste, and has a dry thickness in a range of from about 5 to about 40 μm, resulting in an electrical resistivity in a range of from about 4 to about 100 milliohm/square.

### Outer Dielectric Layers

In one embodiment, a heating element may include an outer dielectric layer on one or both sides of the electrically conductive layers. The outer dielectric layer can act as a barrier layer, preventing environmental degradation of the heating element and preventing unwanted electrical current leakage from the heating element. In one embodiment, an outer dielectric layer can include a polymeric material, such as a polyimide, a tetrafluoroethylene hexafluoropropylene copolymer (FEP), a perfluoroalkoxy polymer (PFA) or a mixture thereof. Examples of polymeric outer dielectric layers include Pyralux® LF and Pyralux® LG (both available from DuPont) and Teflon® FEP and Teflon® PFA (both available from Chemours). In one embodiment, a polymeric material for an outer dielectric layer can include polyvinyl fluoride, polyvinylidene fluoride, polyester (such as polyethylene terephthalate or polyethylene naphthalate), polyether ether ketone, polycarbonate and mixtures thereof. In one embodiment, the outer dielectric layer can include a screen printed or photoimageable epoxy, silicone, filled epoxy, or filled silicone. Examples include FR-4203 (Asahi Rubber) and Pyralux® PC Photoimageable Coverlay (DuPont).

In one embodiment, an outer dielectric layer can be nip or press laminated directly onto the electrically conductive layers before the network structure is formed. In one embodiment, an outer dielectric layer may have a thickness in a range of from about 10 to about 150 μm. In a specific embodiment, an outer dielectric layer may have a thickness in a range of from about 15 to about 75 μm.

### Heating Device

In one embodiment, a heating device can include a polymer-based heating element formed into a honeycomb structure. The honeycomb shape is a more efficient heat sink structure and despite the lower thermal conductivity of the polymer heater layer versus the aluminum of a conventional heat sink, it increases the surface area of the heater and improves the transfer of heat into the convective flow stream. Additionally, this construction removes the requirement for a metallic heat sink, effectively eliminating the thermal interface problem between metallic heat sinks and PTC heating elements, and dramatically reducing the weight of the system.

In one embodiment, to form the heating element with a honeycomb structure, electrodes are first patterned onto electrically conductive layers, for instance on a continuous roll of DuPont Kapton® 200RS100, followed by lines of an adhesive, such as a liquid epoxy adhesive. In another embodiment, where bus bars are integrated into the heating element, bus bars are also patterned onto electrically conductive layers before applying lines of adhesive. The electrodes (and bus bars) are covered with a protective release liner that can be removed after the structure is dipped into the encapsulation resin. The film is then cut into sheets and stacked so that the cell size of the final honeycomb structure is determined by the location of the adhesive of adjacent electrodes (and bus bars). Once the appropriate number of sheets are stacked, they are laminated under high temperature and pressure to adhere the layers together and completely cure the adhesive. This block is attached to a frame and pulled to expand and open the honeycomb cells. In one embodiment, this large honeycomb structure is then dipped into a resin system (phenolic, epoxy, etc.) to form an encapsulant, which provides electrical insulation and mechanical rigidity, if needed. In another embodiment, the honeycomb structure is “thermoformed”, i.e., heated above its glass transition temperature, to provide mechanical rigidity. In one embodiment, the honeycomb structure is both dipped into a resin system to form an encapsulant and heated above its glass transition temperature to thermoform the heating element.

After the structure is dried and cooled, the stack of material is cut separating the sheets into several sections. The cutting will occur between every other section of printed electrodes effectively turning each layer of each section into a uniform heating element. The protective release liner is removed to expose the electrodes (and bus bars). This exposes the electrodes along the short edge where electrical connections can be made. This heating element is then heated (e.g., to a temperature of 300° C. when using Kapton® 200RS100) for a short duration to thermally set the cell structure.

Thus produced is a heating element with a honeycomb structure where all surfaces provide heat and are exposed to the convective air flow of the forced air system. Using a material such as Kapton® 200RS100 allows for the power density to be tailored for each application and even a small increase in power density (0.2 W/cm²) can increase the total output power of the heater by several hundred Watts, depending on the honeycomb construction. The structure also allows for easier construction of unique sizes to meet HVAC system space requirements and utilizes materials with a maximum operating temperature of 240° C. The end result is a heater that fits within the spatial requirements of current heater systems but exceeds all of the performance parameters of current technologies and eliminates many of their construction and performance limitations. In one embodiment, one or more bus bars may be formed separately from the heating element and electrically connected to the heating element after it is formed.

For a heating device, forced convention is created when fluid motion is generated from an external source (e.g. a pump, a suction device or a fan). This fluid (typically air) is directed across the network of electrically conductive layers of the heating element, such as the open cellular network or honeycomb structure described above. When the heating device is powered and the air is directed across the open cellular network, it increases the speed at which the air is heated and allows the warm air to fill a larger space. In one embodiment, a frame or mechanical support structure may be used to provide additional mechanical support for the heating element in the heating device.

Heating devices using heating elements as described herein can be used in a wide variety of application in addition to HEV and EV vehicles. For instance, cartridge heaters in aerospace applications which would benefit from the significant weight reduction of these heating elements, and small household appliance, such as blow dryers, space heaters, electric HVAC heaters, etc.

Note that not all of the activities described above in the general description or the examples are required, that a portion of a specific activity may not be required, and one or more further activities may be performed in addition to those described. Still further, the order in which activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that one or more modifications or one or more other changes can be made without departing from the scope of the invention as set forth in the claims below. Accordingly, the specification and figures are to be regarded in an illustrative rather than a restrictive sense and any and all such modifications and other changes are intended to be included within the scope of invention.

Any one or more benefits, one or more other advantages, one or more solutions to one or more problems, or any combination thereof has been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all of the claims.

It is to be appreciated that certain features of the invention which are, for clarity, described above and below in the context of separate embodiments, may also be provided in combination in a single embodiment.

Conversely, various features of the invention that are, for brevity, described in the context of a single embodiment, may also be provided separately or in any sub-combination. Further, references to values stated in ranges include each and every value within that range.

What is claimed is:

1. A heating element comprising:
a network of electrically conductive layers comprising a plurality of polymeric resistive layers, wherein the polymeric resistive layers have a sheet resistance in a range of from about 0.5 ohm/square to about 2 Megaohm/square; and
two or more electrodes in contact with the network of electrically conductive layers, wherein the array of electrodes electrically connects the heating element to a power source.

2. The heating element of claim 1, wherein the polymeric resistive layers comprise a first polymeric dielectric material.

3. The heating element of claim 2, wherein the first polymeric dielectric material comprises a polyimide.

4. The heating element of claim 1, wherein the first polymeric resistive layers further comprise electrically conductive filler.

5. The heating element of claim 1, wherein the electrically conductive layers further comprise a plurality of polymeric dielectric layers in contact with the plurality of polymeric resistive layers.

6. The heating element of claim 5, wherein the polymeric dielectric layers comprise a second polymeric dielectric material.

7. The heating element of claim 6, wherein the second polymeric dielectric material comprises a polyimide.

8. The heating element of claim 1, wherein the two or more electrodes comprise an electrically conductive paste or a metal.

9. The heating element of claim 1, wherein the network is an open cellular network.

10. The heating element of claim 9, wherein the open cellular network comprises a honeycomb cellular geometry.

11. The heating element of claim 1, wherein the electrically conductive layers further comprise one or more vias.

12. The heating element of claim 1, wherein the electrically conductive layers further comprise one or more outer dielectric layers.

13. The heating element of claim 1, further comprising an encapsulant.

14. The heating element of claim 1, further comprising a frame or mechanical support structure.

15. A forced-convection heating device comprising the heating element of claim 1.

16. The forced-convection heating device of claim 15, further comprising one or more bus bars electrically connected to the heating element.
